(19) United States
(12) Patent Application Publication
(10) Pub. No.: US 2011/0235822 A1
(43) Pub. Date: Sep. 29, 2011

(54) APPARATUS AND METHOD FOR REDUCING REAR NOISE

(76) Inventors: Jae-Hoon JEONG, Yongin-si (KR); Kyu-Hong Kim, Suwon-si (KR); So-Young Jeong, Seoul (KR); Kwang-Cheol Oh, Yongin-si (KR)

(21) Appl. No.: 13/069,063

(22) Filed: Mar. 22, 2011

(30) Foreign Application Priority Data
Mar. 23, 2010 (KR) 10-2010-0025913

(51) Int. Cl. H04R 3/00

(52) U.S. Cl. 381/92

(57) ABSTRACT

An apparatus and method for removing noise are provided. The apparatus includes an acoustic signal input unit configured to comprise three or more microphones including a first microphone as a reference microphone, a second microphone disposed at a position asymmetrical to the first microphone, and a third microphone disposed at a position symmetrical to the first microphone, and an acoustic signal processing unit configured to remove rear noise using acoustic signals received from the first microphone, the second microphone, and the third microphone.

### CROSS-REFERENCE TO RELATED APPLICATION

This application claims the benefit under 35 U.S.C. §119(a) of Korean Patent Application No. 10-2010-0025913, filed on Mar. 23, 2010, in the Korean Intellectual Property Office, the entire disclosure of which is incorporated herein by reference for all purposes.

### BACKGROUND

1. Field

The following description relates to an apparatus and method for removing noise from input sound, and, more particularly, to an apparatus and method for removing noise from input sound using a digital sound acquisition apparatus including a microphone array.

2. Description of the Related Art

In a situation in which a sound source is recorded, or a sound signal is received through a mobile digital device, and so on, various noises and ambient sound are generally included in the sound. To overcome such conditions, a method of amplifying a particular sound source signal that a user wishes to acquire from among the various mixed sounds has been developed. As an alternative, a method of removing unnecessary noises from the various mixed sounds has also been developed. Recently, a desire for a technique for acquiring a target sound source signal more accurately, for example, to have a better quality of sound source signals for video call and voice recognition services, has increased.

### SUMMARY

In one general aspect, there is provided an apparatus to remove noise input from a rear direction, the apparatus including an acoustic signal input unit configured to include three or more microphones including a first microphone as a reference microphone, a second microphone disposed at a position asymmetrical to the first microphone, and a third microphone disposed at a position symmetrical to the first microphone, and an acoustic signal processing unit configured to remove rear noise using acoustic signals received from the first microphone, the second microphone, and the third microphone.

The acoustic signal processing unit may be further configured to include a frequency transformation unit configured to transform a first acoustic signal received by the first microphone, a second acoustic signal received by the second microphone, and a third acoustic signal received by the third microphone, respectively, into acoustic signals in a frequency domain, a phase compensation unit configured to compensate for a phase of the second acoustic signal with respect to sound waves input from the rear direction such that a first directivity direction in which a first phase difference between the first acoustic signal and the second acoustic signal is equal to or smaller than a first threshold value is approximate to a second directivity direction in which a second phase difference between the first acoustic signal and the third acoustic signal is equal to or smaller than a second threshold value, a first direction filter configured to form a first beam in such a direction that the first phase difference between the first acoustic signal and the second acoustic signal with the compensated phase is equal to or smaller than a predetermined threshold value, a second direction filter configured to form a second beam in such a direction that the second phase difference between the first acoustic signal and the third acoustic signal is equal to or smaller than the predetermined threshold value, and a beam processing unit configured to remove an acoustic signal input from the rear direction using the first beam and the second beam.

The symmetrical disposition of the microphones may cause a phase difference between acoustic signals with respect to sound waves input from the back in a perpendicular direction to the apparatus to be equal to or smaller than a certain threshold value and the asymmetrical disposition of the microphones causes a phase difference between the acoustic signals with respect to the sound waves input from the back in a perpendicular direction to the apparatus to be equal to or greater than the certain threshold value.

The phase compensation unit may be further configured to compensate for the phase of the second acoustic signal using a previously stored phase difference in order to make the first directivity direction approximate to the second directivity direction. The previously stored phase difference may be a phase difference between the first acoustic signal and the second acoustic signal with respect to the sound waves input from the back in the perpendicular direction to the apparatus.

The first direction filter may be further configured to form a first weight filter using components of a spectrogram in which a difference between the second acoustic signal with the compensated phase and the first acoustic signal is equal to or smaller than the predetermined threshold value, and apply the first weight filter to the first acoustic signal to obtain a first output signal.

The first direction filter may be further configured to assign a value of 1 to components of the spectrogram in which the phase difference between the first acoustic signal and the second acoustic signal is equal to or smaller than the predetermined threshold value, and assign a value of 0 to the remaining frequency components of the spectrogram to generate the first weight filter.

The second direction filter may be further configured to form a second weight filter using components of a spectrogram in which a phase difference between the third acoustic signal and the first acoustic signal is equal to or smaller than the predetermined threshold value, and apply the second weight filter to the first acoustic signal to obtain a second output signal.

The second direction filter may be further configured to assign a value of 1 to components of the spectrogram in which the phase difference between the first acoustic signal and the third acoustic signal is equal to or smaller than the predetermined threshold value, and assign a value of 0 to the remaining frequency components of the spectrogram to generate the second weight filter.

The beam processing unit may be further configured to form a beam processing filter using frequency components that allow a phase of the first output signal to be smaller than a predefined threshold value and allow a phase of the second output signal to be greater than the predefined threshold value, and apply the beam processing filter to the first acoustic signal to obtain an output signal from which rear noise is removed.

The beam processing unit may be further configured to assign a value of 1 to frequency components that allow the phase of the first output signal to be smaller than the predefined threshold value and allow the phase of the second output signal to be greater than the predefined threshold value, and assign a value of 0 to the remaining frequency components to generate the beam processing filter.

In another general aspect, there is provided a method of removing noise, the method including receiving acoustic signals using an acoustic signal input unit configured to include a first microphone as a reference microphone, a second microphone disposed at a position symmetrical to the first microphone, and a third microphone disposed at a position asymmetrical to the first microphone, transforming a first acoustic signal received by the first microphone, a second acoustic signal received by the second microphone, and a third acoustic signal received by the third microphone, respectively, into acoustic signals in a frequency domain, compensating for a phase of the second acoustic signal with respect to sound waves input from a rear direction such that a first directivity direction in which a first phase difference between the first acoustic signal and the second acoustic signal is equal to or smaller than a first threshold value is approximate to a second directivity direction in which a second phase difference between the first acoustic signal and the third acoustic signal is equal to or smaller than a second threshold value, forming a first beam in such a direction that the first phase difference between the first acoustic signal and the second acoustic signal with the compensated phase is equal to or smaller than a predetermined threshold value, forming a second beam in such a direction that the second phase difference between the first acoustic signal and the third acoustic signal is equal to or smaller than the predetermined threshold value; and removing an acoustic signal input from the rear direction using the first beam and the second beam.

The symmetrical disposition of the microphones may cause a phase difference between acoustic signals with respect to sound waves input from the back in a perpendicular direction to the apparatus to be equal to or smaller than a certain threshold value and the asymmetrical disposition of the microphones causes a phase difference between the acoustic signals with respect to the sound waves input from the back in a perpendicular direction to the apparatus to be equal to or greater than the certain threshold value.

The compensating for the phase may include compensating for the phase of the second acoustic signal using a previously stored phase difference in order to make the first directivity direction approximate to the second directivity direction.

The previously stored phase difference may be a phase difference between the first acoustic signal and the second acoustic signal with respect to the sound waves input from the back in the perpendicular direction to the apparatus.

The forming of the first beam may include forming a first weight filter using components of a spectrogram in which a difference between the second acoustic signal with the compensated phase and the first acoustic signal is equal to or smaller than the predetermined threshold value, and applying the first weight filter to the first acoustic signal to obtain a first output signal.

The forming of the second beam may include forming a second weight filter using components of a spectrogram in which a phase difference between the third acoustic signal and the first acoustic signal is equal to or smaller than the predetermined threshold value, and applying the second weight filter to the first acoustic signal to obtain a second output signal.

The removing of the acoustic signal input from the rear direction may include forming a beam processing filter using frequency components that allow a phase of the first output signal to be smaller than a predefined threshold value and allow a phase of the second output signal to be greater than the predefined threshold value, and applying the beam processing filter to the first acoustic signal to obtain an output signal from which rear noise is removed.

The removing of the acoustic signal input from the rear direction may include assigning a value of 1 to frequency components that allow the phase of the first output signal to be smaller than the predefined threshold value and allow the phase of the second output signal to be greater than the predefined threshold value, and assigning a value of 0 to the remaining frequency components to generate the beam processing filter.

In another general aspect, there is provided an apparatus to remove rear noise, the apparatus including an acoustic signal input unit configured to comprise three or more microphones disposed on a surface which is linearly symmetrical and including one reference microphone, at least one microphone disposed at a position symmetrical to the reference microphone with respect to a line of symmetry of the linearly symmetrical surface, and at least one microphone disposed at a position which is not symmetrical to the reference microphone with respect to the line of symmetry, and an acoustic signal processing unit configured to remove the rear noise using acoustic signals input from the three or more microphones.

The acoustic signal input unit may be further configured to include a first microphone as the reference microphone, a second microphone disposed at a position which is not symmetrical to the first microphone with respect to the line of symmetry, and a third microphone disposed at a position symmetrical to the first microphone with respect to the line of symmetry.

The acoustic signal processing unit may be further configured to include a frequency transformation unit configured to transform a first acoustic signal received by the first microphone, a second acoustic signal received by the second microphone, and a third acoustic signal received by the third microphone, respectively, into acoustic signals in a frequency domain, a phase compensation unit configured to compensate for a phase of the second acoustic signal with respect to sound waves input from the rear direction such that a first directivity direction in which a first phase difference between the first acoustic signal and the second acoustic signal is equal to or smaller than a first threshold value is approximate to a second directivity direction in which a second phase difference between the first acoustic signal and the third acoustic signal is equal to or smaller than a second threshold value, a first direction filter configured to form a first beam in such a direction that the first phase difference between the first acoustic signal and the second acoustic signal with the compensated phase is equal to or smaller than a predetermined threshold value, a second direction filter configured to form a second beam in such a direction that the second phase difference between the first acoustic signal and the third acoustic signal is equal to or smaller than the predetermined threshold value, and a beam processing unit configured to remove an acoustic signal input from the rear direction using the first beam and the second beam.

In another general aspect, there is provided a method of removing rear noise, the method including receiving signals from first, second, and third microphones on a shared surface, the second microphone being asymmetrical on the surface relative to the first microphone, and the third microphone being symmetrical on the surface relative to the first microphone, compensating a phase of a signal received by the second microphone according to a phase difference with the first microphone, and removing portions of the signals of which the phase difference between the first and second microphone is approximately the same as a phase difference between the first and third microphone.

The phase of the signal received by the second microphone may be compensated with respect to sound waves input from a rear perpendicular direction such that the phase difference between the first microphone and the second microphone is equal to or smaller than a first threshold value.

The symmetrical disposition of the microphones may cause a phase difference between the signals with respect to sound waves input from a rear perpendicular direction to be equal to or smaller than a certain threshold value, and the asymmetrical disposition of the microphones causes a phase difference between the signals with respect to the sound waves input from the rear perpendicular direction to be equal to or greater than the certain threshold value.

In another general aspect, there is provided a device including an apparatus to remove noise, the apparatus including first, second, and third microphones provided on a shared surface to receive signals, the second microphone being asymmetrical on the surface relative to the first microphone, and the third microphone being symmetrical on the surface relative to the first microphone, and a controller to compensate a phase of a signal received by the second microphone according to a phase difference with the first microphone, and to remove portions of the signals of which the phase difference between the first and second microphone is approximately the same as a phase difference between the first and third microphone.

The phase of the signal received by the second microphone may be compensated with respect to sound waves input from a rear perpendicular direction such that a phase difference between the first microphone and the second microphone is equal to or smaller than a first threshold value.

Other features and aspects will be apparent from the following detailed description, the drawings, and the claims.

### BRIEF DESCRIPTION OF THE DRAWINGS

FIG. 1 is a diagram illustrating an example of an apparatus to remove rear noise.

FIG. 2 is a diagram illustrating an example of a configuration of the apparatus illustrated in FIG. 1.

FIG. 3A is a diagram illustrating an example of a configuration of an acoustic signal input unit including three microphones.

FIG. 3B is a diagram illustrating an example of a configuration of an acoustic signal input unit including more than three microphones.

FIG. 4A is a diagram illustrating an example of an acoustic signal input unit having microphones located asymmetrically to each other.

FIG. 4B is a diagram illustrating an example of the presence of incident sound waves moving in a particular direction which allows phases of sound sources of two microphones to be the same as each other.

FIG. 4C is a graph illustrating an example of phases of acoustic signals received respectively by a reference microphone, an asymmetrical microphone, and a symmetrical microphone of the acoustic signal input unit illustrated in FIG. 4B.

FIG. 5 is a diagram illustrating an example of a region in the form of a beam in which a phase difference of the acoustic signals received by two microphones located at positions symmetrical to each other is small.

FIG. 6A is a diagram illustrating an example of a region in the form of a beam in which a phase difference of acoustic signals received by two microphones located at positions asymmetrical to each other is small.

FIG. 6B is a diagram illustrating an example of a region in the form of a beam in which a phase difference of the acoustic signals of FIG. 6A, which have their phases compensated, is small.

FIG. 7 is a diagram illustrating an example of operation of the first direction filter illustrated in FIG. 2.

FIG. 8 is a diagram illustrating an example of how to remove rear noise.

FIG. 9A is a diagram illustrating an example of an operation of the beam processing unit illustrated in FIG. 2.

FIG. 9B is a diagram illustrating an example of operation of generating an output signal from which rear noise is removed through processing by a beam processing filter.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

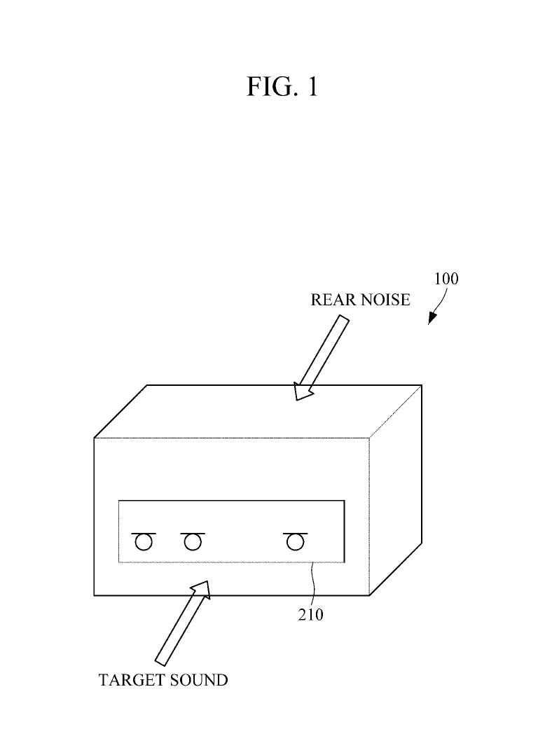

FIG. 1 illustrates an example of an apparatus to remove rear noise. The apparatus 100 may include an acoustic signal input unit 210 having a plurality of microphones. Such a microphone array is used to receive desired sound from a specific direction, i.e., the direction facing the array of microphones. As indicated in the example illustrated in FIG. 1, acoustic signals may be transferred to the apparatus 100 from a target sound source located in front of the apparatus 100 and from a rear sound source located behind the apparatus 100. As previously stated, various sounds are emitted from various sound sources, and typically the sounds from a sound source facing the acoustic signal input unit 210, or the front of the apparatus 100, are desired more than the sounds from a sound source facing the rear of the acoustic signal input unit 210, or the back of the apparatus 100.

As indicated in the example illustrated in FIG. 1, in a case in which a broadside microphone is used, and sound is therefore input in a perpendicular direction to an axis of a microphone array, noises from positions symmetrical to the target sound source with respect to the microphone array may flow into the microphone. The apparatus 100 may use symmetrical and asymmetrical disposition of the microphones to receive the target sound input from the front and reduce the noise from the rear, therefore achieving a cleaner sound signal from the desired sound source.

The apparatus 100 may be implemented in various electronic devices such as, for example, and as a non-exhaustive illustration only, a personal computer, a laptop computer, a mobile phone, a personal digital assistant (PDA), a portable/personal multimedia player (PMP), an MP3 player, a game controller, a TV input device, a portable game console, a digital camera, a global positioning system (GPS) navigation, and the like.

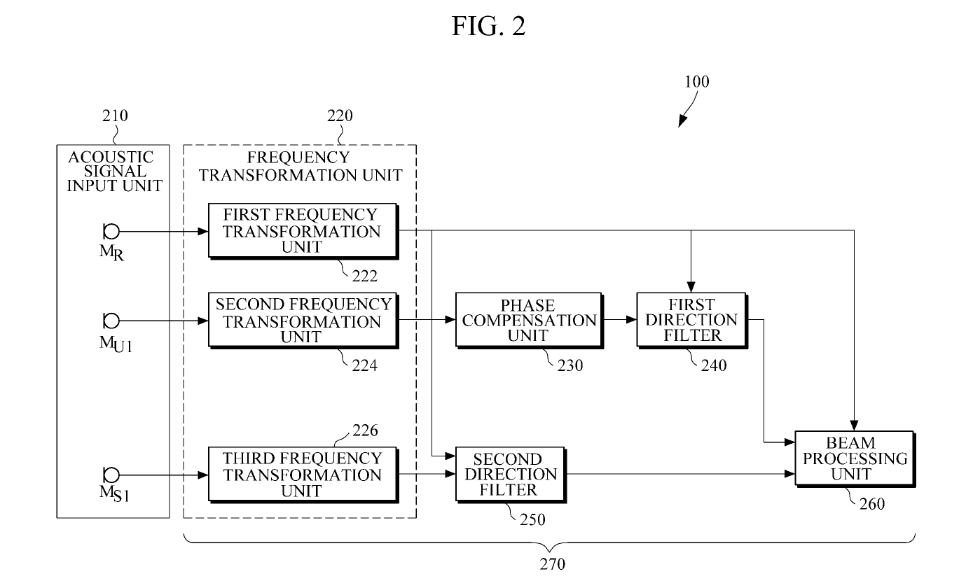

FIG. 2 illustrates an example of an apparatus to remove rear noise. The apparatus 100 may include an acoustic signal input unit 210, a frequency transformation unit 220, a phase compensation unit 230, a first direction filter 240, a second direction filter 250, and a beam processing unit 260. The frequency transformation unit 220, the phase compensation unit 230, the first direction filter 240, the second direction filter 250, and the beam processing unit 260 correspond to an acoustic signal processing unit 270 that removes rear noise. However, the illustrated inclusion and configuration of these elements are merely an example of the acoustic signal processing unit 270, and various elements may be altered, omitted, and/or substituted according to various desired situations.

The acoustic signal input unit 210 may include a microphone array having three or more microphones. In the apparatus 100, a first microphone 112 may be provided as a reference microphone, and two or more additional microphones may be provided that are either symmetrical or asymmetrical to the first microphone 112. In more detail, a microphone that is asymmetrical to the first microphone 112 outputs a sound signal with a phase that is asymmetrical to a phase of a sound signal output from the first microphone 112, and a microphone that is symmetrical to the first microphone 112 outputs a sound signal with a phase that is symmetrical to the phase of the sound signal output from the first microphone 112. A symmetrically placed microphone will be symmetrical to the reference microphone relative to a line on a linearly symmetrical surface provided with the microphones that divides the surface into two symmetric halves. Also, as described later, it may not be necessary to have a perfectly symmetrical surface in order to have symmetrically provided microphones.

In the example illustrated in FIG. 2, a second microphone 114 may be provided at a position asymmetrical to the first microphone 112, and a third microphone 116 may be located at a position symmetrical to the first microphone 112. In this case, although the acoustic signal input unit 210 is described as including three microphones for convenience of explanation, it may include four or more microphones, which may be located at positions symmetrical or asymmetrical to each other.

In a case in which the microphones are located at positions symmetrical to each other, a phase difference between acoustic signals with respect to sound waves input in a perpendicular direction to the apparatus 100 from the rear of the apparatus 100 may be smaller than a certain threshold value. If the microphones are located at positions perfectly symmetrical to each other, the phase difference between the acoustic signals input to the microphones from among the sound waves input in a perpendicular direction to the apparatus 100 from the rear of a surface on which the microphones are located may be 0. However, in practice, in consideration of manufacturing errors, even in a case in which the phase difference is close to 0, the microphones may be considered to be located at positions symmetrical to each other. In a case in which the microphones are regarded as being located at positions asymmetrical to each other, it indicates that the microphones are not located at positions symmetrical to each other. That is, if the microphones are located at positions asymmetrical to each other, a phase difference between acoustic signals input to the microphones with respect to sound waves input in a perpendicular direction to the back may be greater than the certain threshold value.

In addition, in the case of the microphones being located on the same surface, if the surface is linearly symmetrical in a geometric view, the symmetrical and the asymmetrical dispositions of the microphones may be defined as described below.

A linearly symmetrical figure may be a figure that has a half with the same dimensions as the other half when it is folded with respect to a line (or axis) of symmetry. Homologous sides of the linearly symmetrical figure have the same length, homologous angles also have the same value, and a line between homologous points of the figure is bisected by the line (or axis) of symmetry and perpendicularly meets the axis of symmetry. The linearly symmetrical figure may be, for example, rectangular, pentagonal, hexagonal, and the like.

A symmetrical disposition is a disposition in which microphones are located at positions symmetrical to a position of a single reference microphone with respect to a line of symmetry on a linearly symmetrical surface. An asymmetrical disposition is a disposition in which microphones are located at positions which are not symmetrical to a position of a single reference microphone with respect to a line of symmetry on a linearly symmetrical surface. The position of the reference microphone may be defined arbitrarily.

Even in a case in which a surface on which a microphone array is located is not perfectly linearly symmetrical, once imaginary lines extended from both edge microphones of the microphone array to the surface are identical with each other in length, the microphone array can be considered as symmetrical or asymmetrical as described above, and thus the present invention is applicable to such microphone array.

Hereinafter, a surface on which the microphones 112, 114, and 116 are located is referred to as a “surface A” for convenience of explanation.

The first microphone 112 may be a reference microphone M_{R}. The second microphone 114 may be a microphone M_{U1} which is paired with the first microphone 112 in an asymmetrical disposition. An acoustic signal received through the first microphone 112 may be referred to as a first acoustic signal, and an acoustic signal received through the second microphone 114 may be referred to as a second acoustic signal. With respect to sound waves input in a perpendicular direction to the rear of surface A, a phase difference between the first acoustic sound and a second acoustic sound may be equal to or greater than a previously defined certain threshold value. One or more asymmetrical microphones may be provided. The certain threshold value may be previously defined as any value close to 0.

The third microphone 116 may be a microphone MS1 which is paired with the first microphone 112 in a symmetrical disposition. In a case in which an acoustic signal received through the third microphone 116 is referred to as a third acoustic signal, a phase difference between the first acoustic signal and the third acoustic signal with respect to the sound waves input in a perpendicular direction to the rear of surface A may be equal to or smaller than the certain threshold value. One or more symmetrical microphones, in addition to the reference microphone, may be provided.

The acoustic signal processing unit 270 may be configured to remove rear noise using the acoustic signals received from the three microphones 112, 114, and 116.

The frequency transformation unit 220 may transform the acoustic signals input through the acoustic signal input unit 210 into acoustic signals in a frequency domain. For example, the frequency transformation unit 220 may transform an acoustic signal in a time domain into an acoustic signal in a frequency domain using a discrete Fourier transform (DFT) or fast Fourier transform (FFT). The frequency transformation unit 220 may divide a temporally input acoustic signal into frames, and transform the acoustic signal into an acoustic signal in a frequency domain on a frame-by-frame basis. The unit of frame may be determined according to sampling frequency, a type of an application, and the like.

The frequency transformation unit 220 may include a first frequency transformation unit 222 which transforms the first acoustic signal into an acoustic signal in a frequency domain, a second frequency transformation unit 224 which transforms the second acoustic signal into an acoustic signal in a frequency domain, and a third frequency transformation unit 226 which transforms the third acoustic signal into an acoustic signal in a frequency domain. Hereinafter, transformation from a temporally input acoustic signal into an acoustic signal in a frequency domain will be referred to as a “spectrogram.”

The phase compensation unit 230 may compensate for a phase difference between the first acoustic signal transformed into an acoustic signal in a frequency domain and the second acoustic signal transformed into an acoustic signal in a frequency domain with respect to the sound waves input in a perpendicular direction to the rear of surface surface A. The compensation for the phase difference may include compensation for a phase which allows the phase difference to be equal to or smaller than a threshold value. That is, with respect to the sound waves incoming from the back, or from behind the surface upon which the microphones are provided, the phase compensation unit 230 may compensate for a phase of the second acoustic signal such that a first directivity direction in which a first phase difference between the first acoustic signal and the second acoustic signal is equal to or smaller than a first threshold value can be close to a second directivity direction in which a second phase difference between the first acoustic signal and the third acoustic signal is equal to or smaller than a second threshold value. The second threshold value may be the certain threshold value to satisfy the symmetrical deposition of the microphones. The first threshold value may be greater than the second threshold value.

The phase compensation unit 230 may compensate for the phase of the second acoustic signal using a previously stored phase difference value in order to make the first directivity direction close to the second directivity direction. The previously stored phase difference value may be a phase difference between the first acoustic signal and the second acoustic signal with respect to sound waves input in a perpendicular direction to the back of the apparatus 100.

The first direction filter 240 and the second direction filter 250 may be configured to filter an acoustic signal input in a particular direction. The particular direction may be an arbitrary direction, and once the direction is defined, a phase difference between microphones may be set according to the direction. However, in the example described herein, the particular direction may be a direction in which there is no phase difference between acoustic signals received by the microphones, or the phase difference is equal to or smaller than a predetermined threshold value that is close to 0.

The first direction filter 240 may form a first beam in a direction in which a phase difference between the first acoustic signal and the second acoustic signal with a compensated phase is equal to or smaller than the predetermined threshold value. The first direction filter 240 may form a first weight filter (not illustrated) using components of a spectrogram in which a phase difference between the first acoustic signal and the second acoustic signal with the compensated phase is equal to or smaller than the predetermined threshold value, and may obtain a first output signal by applying the first weight filter to the first acoustic signal. The first direction filter 240 may assign a value of 1 to components of the spectrogram in which a phase difference between the first acoustic signal and the second acoustic signal is equal to or smaller than the predetermined threshold value, and may assign a value of 0 to the remaining components of the spectrogram to generate the first weight filter.

The second direction filter 250 may form a second beam in a direction in which a phase difference between the first acoustic signal and the third acoustic signal is equal to or smaller than the predetermined threshold value. The second direction filter 260 may form a second weight filter (not illustrated) using components of a spectrogram in which the phase difference between the third acoustic signal and the first acoustic signal is equal to or smaller than the predetermined threshold value, and may obtain a second output signal by applying the second weight filter to the first acoustic signal. The second direction filter 260 may assign a value of 1 to components of the spectrogram in which the phase difference between the first acoustic signal and the third acoustic signal is equal to or smaller than the predetermined threshold value, and may assign a value of 0 to the remaining components of the spectrogram to generate the second weight filter.

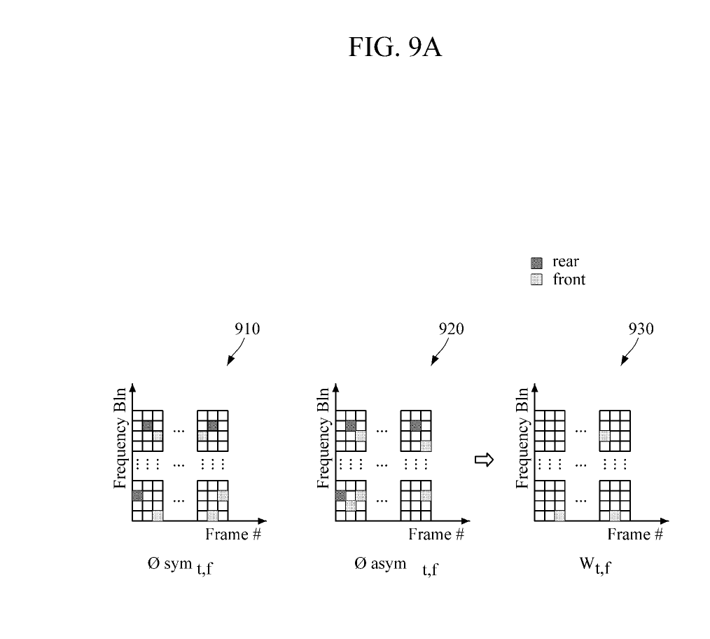

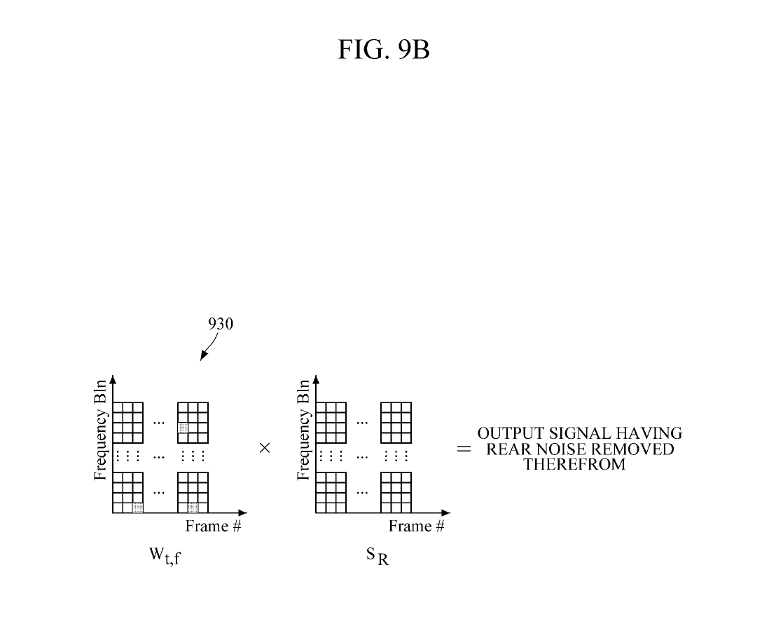

The beam processing unit 260 may use the first beam and the second beam to remove a rear acoustic signal input to the apparatus 100. The beam processing unit 260 may remove a beam received from the back of the apparatus 100 using a beam from an asymmetrical microphone and a beam with a compensated phase from a symmetrical microphone. The beam processing unit 260 may form a beam processing filter (930 in an example illustrated in FIG. 9) using components of a spectrogram in which a phase of the first output signal is smaller than a predefined threshold value and a phase of the second output signal is greater than the predefined threshold value, and obtain an output signal from which rear noise is removed by applying the beam processing filter to the first acoustic signal. In addition, the beam processing unit 260 may assign a value of 1 to the components of the spectrogram in which a phase of the first output signal is smaller than the predefined threshold value and a phase of the second output signal is greater than the predefined threshold value, and assign a value of 0 to the remaining components of the spectrogram to generate the beam processing filter.

Although the apparatus 100 is described as including three microphones in the example illustrated in FIG. 2, the apparatus 100 may include four or more microphones and thereby have other elements expanded. For example, if an additional asymmetrical microphone is added, the apparatus 100 may further include an additional frequency transformation unit that transforms an acoustic signal received by the added microphone into an acoustic signal in a frequency domain, an additional phase compensation unit, and an additional first direction filter. In addition, an element that forms a single beam using a number of first beams formed by various asymmetrical microphones may be further included. Such additional components may be provided as discrete components, or in combination with other additional components or components already described.

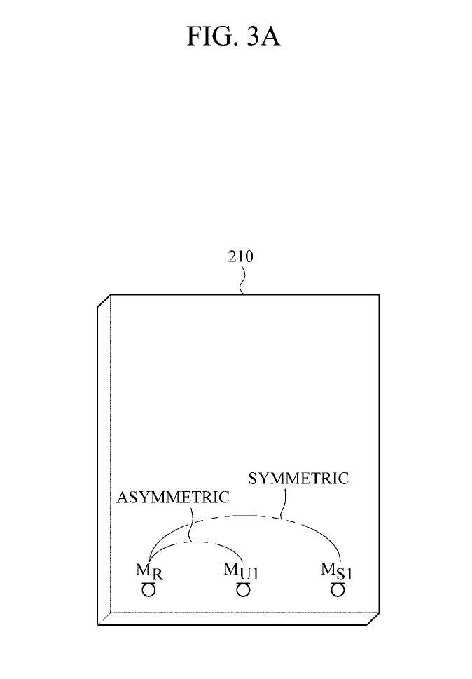

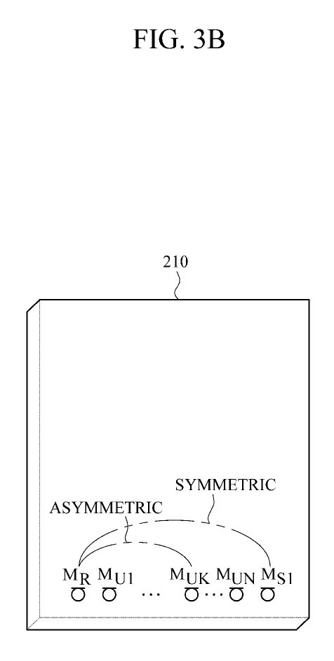

FIG. 3A illustrates an example of a configuration of an acoustic signal input unit including three microphones, and FIG. 3B illustrates an example of a configuration of an acoustic signal input unit including more than three microphones.

Referring to the example illustrated in FIG. 3A, a middle microphone M_{U1} may be paired with a reference microphone M_{R} on the left as an asymmetrical microphone pair. A microphone M_{S1} provided to the right of the middle microphone M_{U1} may be paired with the reference microphone M_{R} as a symmetrical microphone pair. In the symmetrical microphone pair, among acoustic signals input to the paired microphones, phases of acoustic signals input in a perpendicular direction to a rear surface of the acoustic signal input unit 210 which are input to each of the microphones are the same as each other. In the asymmetrical microphone pair, among acoustic signals input to the paired microphones, phases of acoustic signals input in a perpendicular direction to the rear surface of the acoustic signal input unit 210 which are input to each of the microphones are different from each other. A surface A on which the microphones are adhered may be, for example, a rectangle or any other shape.

FIG. 3B illustrates an example showing a symmetrical disposition and an asymmetrical disposition of more than three microphones.

As indicated in the example illustrated in FIG. 3B, a plurality of asymmetrical microphones may be included. One or more symmetrical microphones M_{S1} may be included according to the shape of a surface A on which the microphones are adhered. Furthermore, the microphones may be adhered to any location such as a lower surface or a side surface of the apparatus 100, as long as the location satisfies conditions for symmetry and asymmetry. Also, as previously described, the symmetry of the symmetric microphones may be approximate, and the surface does not necessarily have to be perfectly linearly symmetrical relative to a line dividing the surface into two parts, provided that the distances between the respective symmetrical microphones and the line of approximate symmetry is approximately equal.

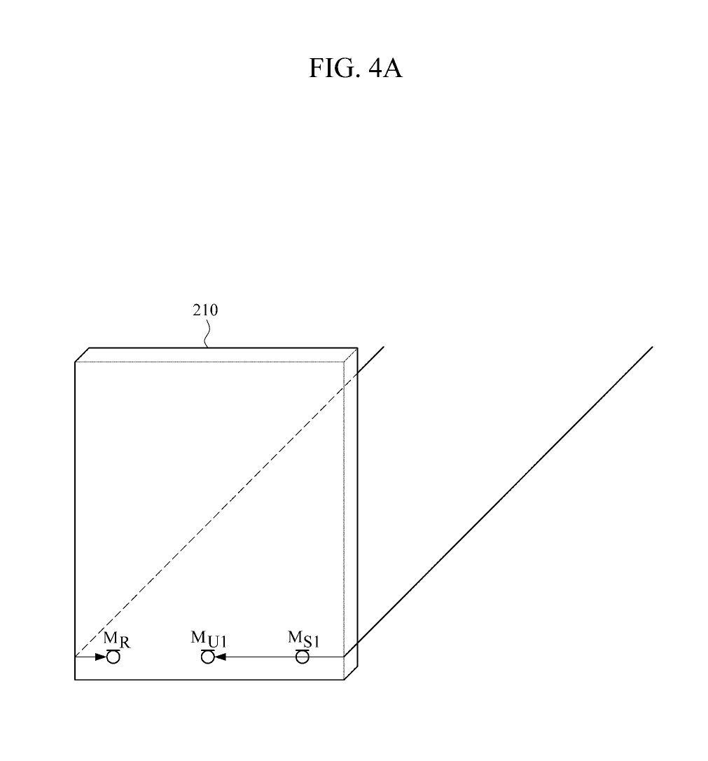

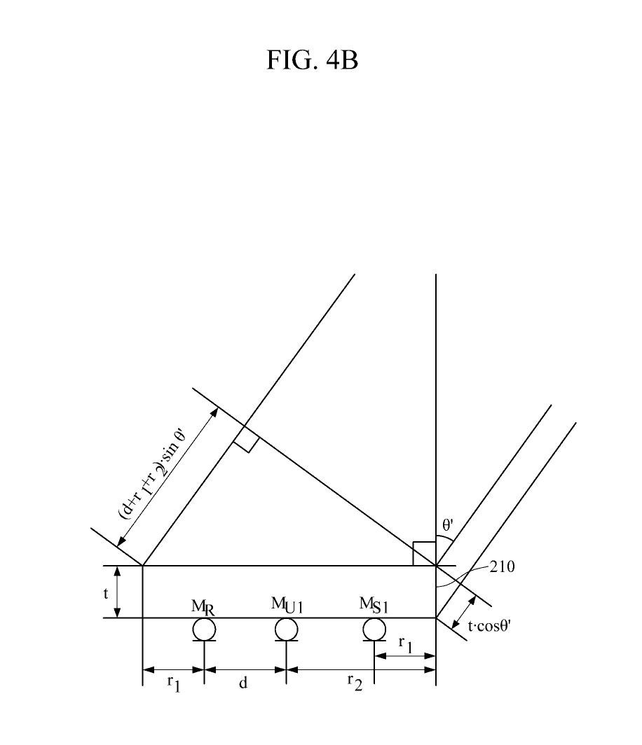

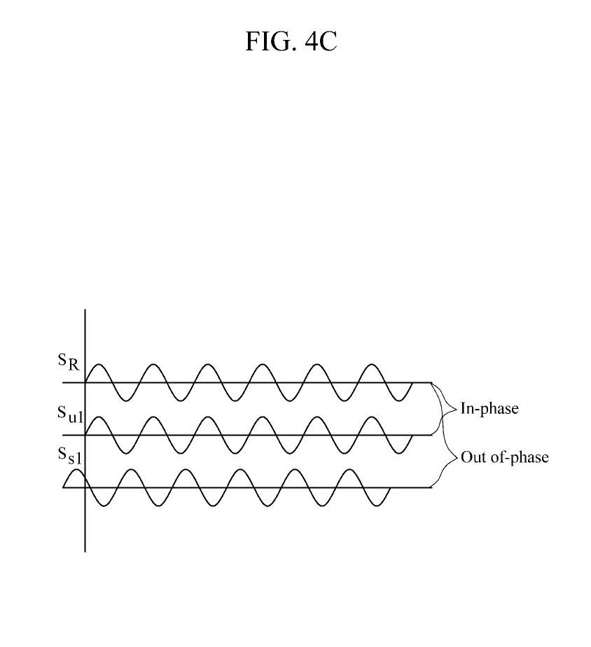

FIG. 4A illustrates an example of an acoustic signal input unit having microphones located asymmetrically to each other, and FIG. 4B illustrates an example of the presence of incident sound waves moving in a particular direction which allows phases of sound sources of two microphones to be the same as each other. Referring to the example illustrated in FIG. 4A, an input of sound waves from the back of the acoustic signal input unit to a reference microphone M_{R}, a symmetrical microphone M_{S1}, and an asymmetrical microphone M_{U1} is represented by the illustrated arrows. In the example illustrated in FIG. 4B, the propagation path of the sound waves causes directions allowing the same phase with respect to the reference microphone M_{R} and the asymmetrical microphone M_{U1} in a case in which sound waves input from the back of the acoustic signal input unit are not perpendicular to the front surface of the acoustic signal input unit 210, but are incident in another particular direction.

Although the sound waves are generally incident to the microphones in various directions, for convenience of explanation, only two propagation paths of the sound waves are considered in the example illustrated in FIG. 4A. In this case, a phase is measured in consideration of sound waves that first arrive at the microphones M_{R} and M_{U1}, and it may be noted that there are present directions that allow the phases of the acoustic signals input to the microphones M_{R} and M_{U1} to be the same as each other.

Referring to the example illustrated in FIG. 4B, Equation 1 is established in consideration of two sound waves among sound waves transmitted at an angle of θ′, relative to a direction perpendicular to the front surface of the acoustic signal input unit 210, which have the same phase with respect to the reference microphone M_{R} and an asymmetrical microphone M_{U1} wherein a propagation distance from a sound source of one sound wave to the reference microphone M_{R} is identical to a propagation distance from a sound source of the other sound wave to the asymmetrical microphone M_{U1}.

(d+r₁+r₂)·sinθ′+t+r₁=t·cosθ′+r₂ (1)

Equation 1 may be rearranged, in terms of t·cosθ′, as follows: t·cosθ′=(d+r₁+r₂)·sinθ′+t+r₁−r₂. r₂. Since (t·cosθ′)²+(t·sinθ′)²=t², if t·cosθ′=(d+r₁+r₂)·sinθ′+t+r₁−r₂ is substituted to (t·cosθ′)²+(t·sinθ′)²=t², θ′ can be obtained.

In this example, d denotes a distance between the reference microphone M_{R} and the asymmetrical microphone M_{U1}, r₁ denotes a distance from the left side of the apparatus 100 to the reference microphone M_{R}, and r₂ denotes a distance from the right side of the apparatus 100 to the asymmetrical microphone M_{U1}. t denotes a thickness of the side of the apparatus 100. θ′ denotes an angle, relative to a direction perpendicular to the front surface of the acoustic signal input unit 210, at which a phase of the acoustic signal input to the reference microphone M_{R} becomes the same as a phase of the acoustic signal input to the asymmetrical microphone M_{U1}.

FIG. 4C is a graph illustrating an example of phases of acoustic signals received respectively by the reference microphone M_{R}, the asymmetrical microphone M_{U1}, and the symmetrical microphone M_{S1} of the acoustic signal input unit 210 in the example illustrated in FIG. 4B.

There may be no phase difference between an acoustic signal S_{R} received by the reference microphone M_{R} and an acoustic signal S_{U1} received by the asymmetrical microphone M_{U1} with respect to the sound waves input at an angle of θ′ as indicated in the example illustrated in FIG. 4C. In addition, with respect to the sound waves input at the angle of θ′, there may be a phase difference between the acoustic signal S_{R} received by the microphone M_{R} and an acoustic signal S_{S1} received by the symmetrical microphone M_{S1}, as illustrated in FIG. 4C.

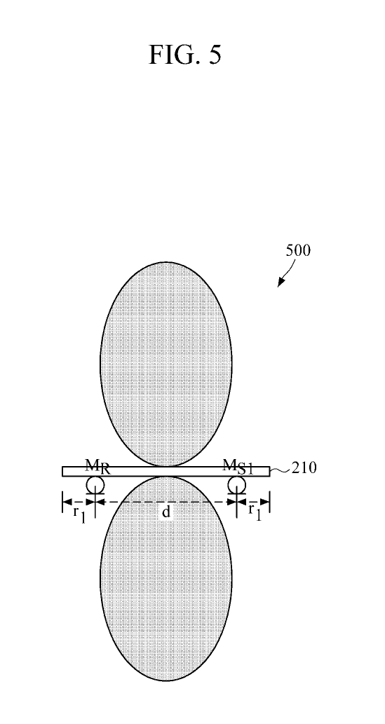

FIG. 5 illustrates an example of a region in the form of a beam in which a phase difference of the acoustic signals received by two microphones located at positions symmetrical to each other is small.

In the example illustrated in FIG. 5, the beam 500 represents a region in which there is no phase difference between acoustic signals received by a reference microphone M_{R} and a symmetrical microphone M_{S1} which are symmetrically located, or the phase difference is equal to or smaller than the certain threshold value. The second direction filter 250 in the example illustrated in FIG. 2 may filter an acoustic signal in the region in the form of the beam 500 of FIG. 5. The beam 500 may correspond to the second beam generated by the second direction filter 250. With respect to the microphones at positions symmetrical to each other, the region in which the phase difference of the acoustic signals is small may be formed in a perpendicular direction to the surface A, on front and back sides of which the microphones are disposed, as indicated in the example illustrated in FIG. 5.

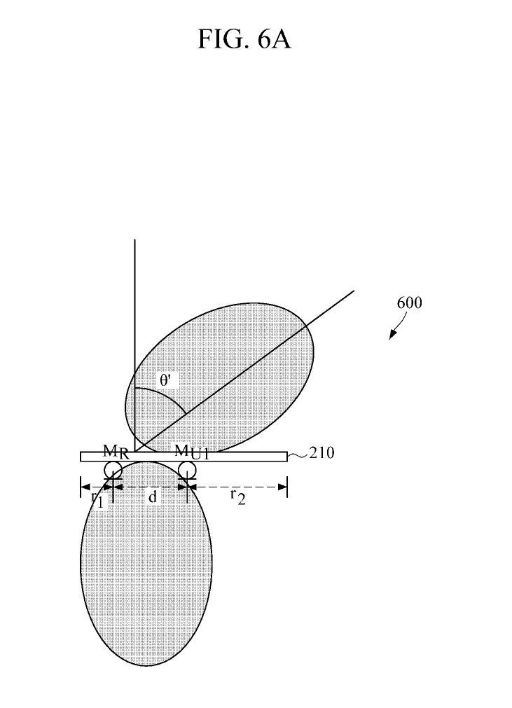

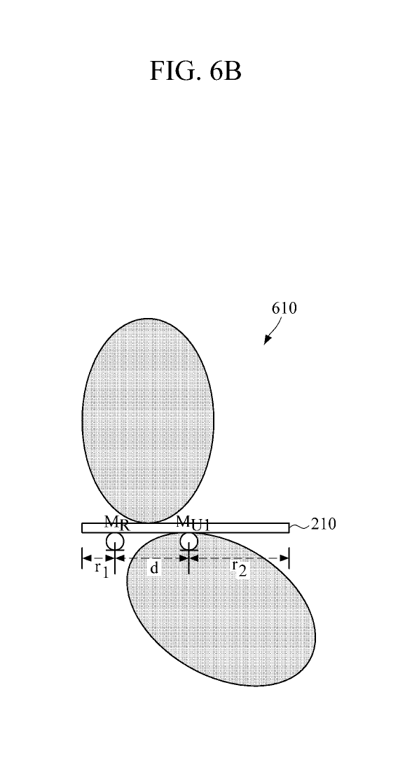

FIG. 6A illustrates an example of a region in the form of a beam in which a phase difference of acoustic signals received by two microphones located at positions asymmetrical to each other is small, and FIG. 6B illustrates an example of a region in the form of a beam in which the acoustic signals of FIG. 6A have their phases compensated.

Referring to the example illustrated in FIG. 6A, a direction in which the acoustic signals received by the microphones M_{R} and M_{U1} located asymmetrically to each other have the same phase is determined to be tilted at a particular angle of θ′ with respect to sound waves input perpendicularly from the back, and determined to be perpendicular to the front with respect to sound waves input from the front. In the meantime, a frequency having a wavelength longer than a size of a structure to which the microphone is adhered is diffracted, thereby allowing frequencies to have the same size. The sound waves from the back may be smaller than the structure to which the microphone is adhered.

FIG. 6B illustrates an example of a region in the form of a beam in which a phase difference of sound sources of the two microphones is small after the phases of the acoustic signals are compensated.

In the example illustrated in FIG. 6B, the beam 610 represents a region in which there may be no phase difference between an acoustic signal of the reference microphone M_{R} and the acoustic signal of the asymmetrical microphone M_{U1}, or the phase difference may be equal to or smaller than the certain threshold value as the result of compensation for the phase of the acoustic signal of the asymmetrical microphone M_{U1}. As the result of compensation for the phase of the acoustic signal of the asymmetrical microphone M_{U1}, a front angle of the beam 610 is accordingly compensated for, and thus the beam is tilted as indicated in the example illustrated in FIG. 6B. An acoustic signal in a region in the form of the beam 610 in the example illustrated in FIG. 6B may be filtered by the first direction filter 240 illustrated in FIG. 2. The beam 610 may correspond to the first beam generated by the first direction filter 240.

To compensate for a phase, as represented by Equation 2 below, a phase difference between an acoustic signal received by the reference microphone M_{R} and an acoustic signal received by the asymmetrical microphone M_{U1} in a rear perpendicular direction may be subtracted from a phase difference between the acoustic signal received by the reference microphone M_{R} and the acoustic signal received by the asymmetrical microphone M_{U1}. As shown in the fourth line in Equation 4, a phase (∠S_{U1}|_{θ=α}) of the acoustic signal of the asymmetrical microphone M_{U1} is added to a phase difference (∠S_{R}|_{θ=0}−∠S_{U1}|_{θ=0}) between the phase of the acoustic signal of the reference microphone M_{R} and the phase of the acoustic signal of the asymmetrical microphone M_{U1} with respect to the acoustic signal input in a rear perpendicular direction.

ΔΦ_{θ=0}=∠S_{R}|_{θ=0}−∠S_{U1}|θ=0

ΔΦ_{θ=α}=∠S_{R}|_{θ=α}−∠S_{U1}|_{θ=α}−ΔΦ_{θ=0}

=∠S_{R}|_{θ=α}−∠S_{U1}|_{θ=α}−(∠S_{R}|_{θ=0}−∠S_{U1}|_{θ=0})

=∠S_{R}|_{θ=α}−[∠S_{U1}|_{θ=α}+(∠S_{R}|_{θ=0}−∠S_{U1}|_{θ=0})]

That is, as described with reference to FIG. 2, the phase compensation unit 230 may compensate for the phase of the second acoustic signal using a phase difference between the first acoustic signal and the second acoustic signal with respect to sound waves input in a perpendicular direction to the back of the apparatus, so that the first directivity direction can be approximate to the second directivity direction. The phase difference between the first acoustic signal and the second acoustic signal may be previously stored in the rear noise removing apparatus 100.

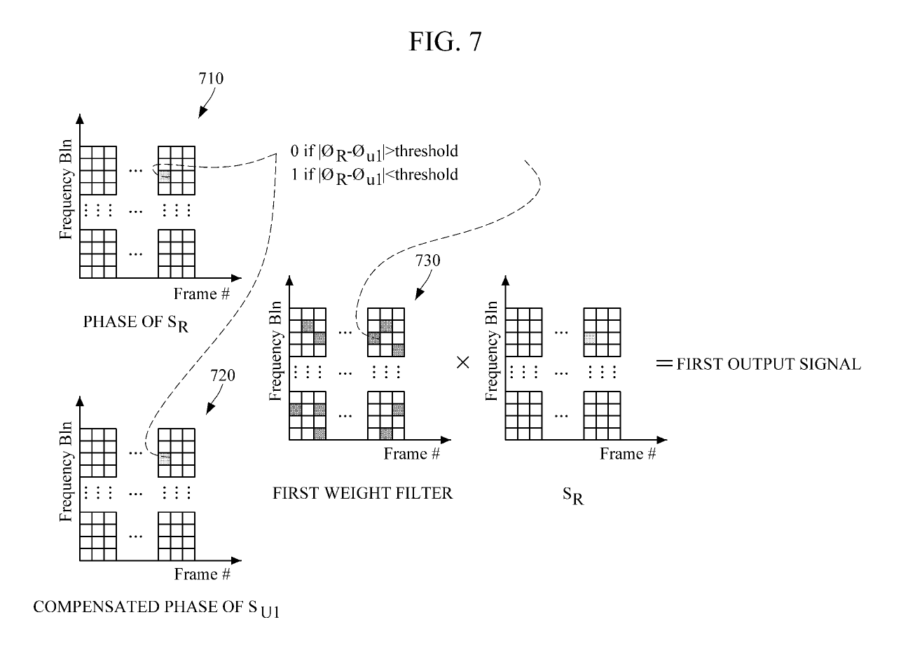

FIG. 7 illustrates an example of operation of the first direction filter illustrated in FIG. 2.

The first direction filter 240 may form a first beam in a direction in which a phase difference between the first acoustic signal and the second acoustic signal with a compensated phase is equal to or smaller than the predetermined threshold value. To this end, the first direction filter 240 may form a first weight filter using components of a spectrogram in which the phase difference between the first acoustic signal and the second acoustic signal with the compensated phase is equal to or smaller than the predetermined threshold value.

Reference numeral 710 denotes phase information of the first acoustic signal which is converted into an acoustic signal in a frequency domain by the first frequency conversion unit 222 on a time frame-by-time frame basis according to time flow. That is, 710 denotes a phase Φ_{R} in a time-frequency domain of the first acoustic signal S_{R}.

Reference numeral 720 denotes a phase Φ_{U1} in a time-frequency domain of the second acoustic signal S_{U1} with the compensated phase. The first direction filter 240 may assign a value of 1 to components of the spectrogram in which a phase difference between the phase Φ_{R} in a time-frequency domain of the first acoustic signal and the phase Φ_{U1} in a time-frequency domain of the second acoustic signal S_{U1} with the compensated phase is equal to or smaller than the predetermined threshold value, and assign a value of 0 to the remaining components of the spectrogram to generate a first weight filter 730. The first weight filter 730 may be applied to the first acoustic signal S_{R} to obtain a first output signal. Although it is described that the first weight filter 730 is applied to the first acoustic signal S_{R} to generate the first output signal in this example, the application of the first weight filter 730 to the second acoustic signal S_{U1} may produce the same result.

The second direction filter 250 may perform operations in the same manner as the first direction filter illustrated in FIG. 7, except that a phase Φ_{U1} of the second acoustic signal S_{U1} with the compensated phase may be substituted by a phase Φ_{S1} of the third acoustic signal S_{S1}. More specifically, the second direction filter 250 may form a second weight filter using components of a spectrogram in which a phase difference between the third acoustic signal and the first acoustic signal is equal to or smaller than the predemined threshold value. The second direction filter 250 may assign a value of 1 to components of the spectrogram in which the phase difference between the first acoustic signal and the third acoustic signal is equal to or smaller than the predetermined threshold value, and may assign a value of 0 to the remaining components of the spectrogram to generate a second weight filter. The second direction filter 250 may apply the second weight filter to the first acoustic signal to generate a second output signal.

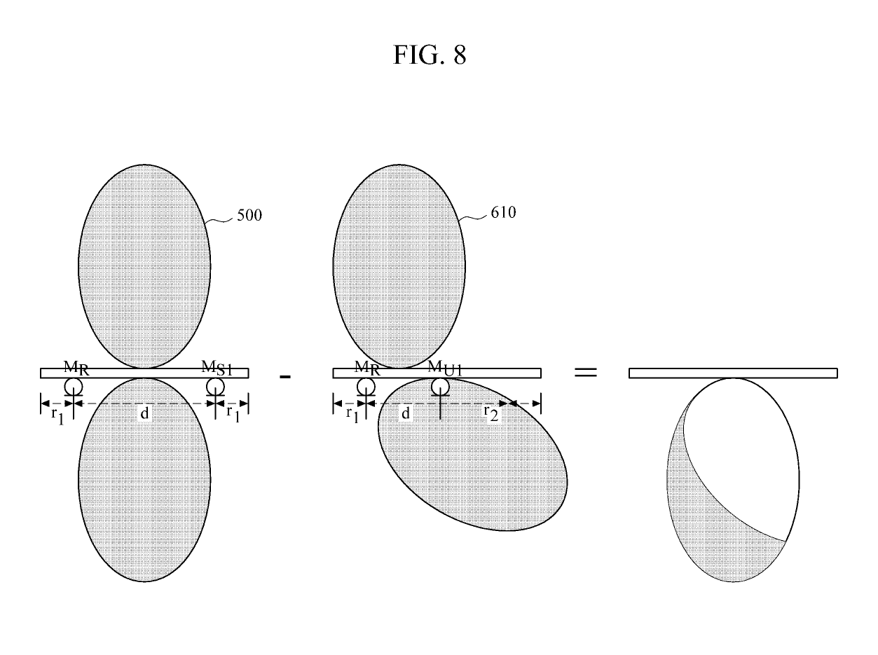

FIG. 8 is a diagram illustrating an example of how to remove rear noise.

In the example illustrated in FIG. 8, procedures of removing rear noise are represented in the form of a beam, in which the rear noise is removed using a phase difference of acoustic signals input to microphones at positions symmetrical to each other and a phase difference of acoustic signals input to microphones at positions asymmetrical to each other and having their phases compensated.

In the example illustrated in FIG. 8, it may be assumed that an acoustic signal in the form of a beam which is received by an asymmetrical microphone is subtracted from an acoustic signal in the form of a beam which is received by a symmetrical microphone so as to remove sound input from the back. However, the rear noise removal does not mean actual subtraction of an acoustic signal in the form of a beam, and it may be performed by signal processing as indicated in examples illustrated in FIGS. 9A and 9B.

FIG. 9A is a diagram illustrating an example of operation of the beam processing unit 260 of the rear noise removing apparatus 100, and FIG. 9B is a diagram illustrating an example of an operation of generating an output signal from which rear noise is removed through processing by a beam processing filter.

Referring to the examples illustrated in FIGS. 2 and 9A, the beam processing unit 260 may use a beam 500 formed by microphones at positions symmetrical to each other and a beam 610 of an asymmetrical microphone which is obtained by compensating for a phase of an acoustic signal input to the asymmetrical microphone to remove a beam in a rear direction. It is assumed that a phase of a first output signal is represented as Φ_{t, f}^{sym} 910, and a phase of a second output signal is represented as Φ_{t, f}^{asym} 920. In the example illustrated in FIG. 9A, it may be noted that a phase component of a rear spectrogram is placed in common on each of Φ_{t, f}^{sym} 910 and Φ_{t, f}^{asym} 920, and signal processing is performed such that a directivity direction of a first beam can be identical with a directivity direction of a second beam.

The beam processing unit 260 may form a beam processing filter using a frequency component which allows the phase Φ_{t, f}^{sym} 910 of the first output signal to be smaller than the predefined threshold value, and allows the phase Φ_{t, f}^{asym} 920 of the second output signal to be greater than the predefined threshold value.

The beam processing unit 260 may assign a value of 1 to a weight ω_{t, f} for the frequency component which allows the phase Φ_{t, f}^{sym} 910 of the first output signal to be smaller than the predefined threshold value and allows the phase Φ_{t, f}^{asym} 920 of the second output signal to be greater than the predefined threshold value, and may assign a value of 0 to a weight ω_{t, f} for the remaining frequency components so as to generate the beam processing filter 930. This may be represented as Equation 3 below.

$${ω}_{t , f} = \{ \begin{matrix}1 , & {Φ}_{t , f}^{sym} < δ and {Φ}_{t , f}^{asym} > δ \\ 0 , & else\end{matrix}$$

Here, δ denotes the predefined threshold value, and may be determined experimentally.

As indicated in the example illustrated in FIG. 9B, the beam processing unit 260 may apply the beam processing filter 930 to the first acoustic signal S_{R} to obtain an output signal from which rear noise is removed. Although, in this example, the first acoustic single S_{R} may be applied with the beam processing filter 930, and the second acoustic signal S_{U1} or the third acoustic signal S_{S1} may be applied with the beam processing filter 930 so as to obtain an output signal from which rear noise is removed. The current embodiments can be implemented as computer readable codes in a computer readable record medium. Codes and code segments constituting the computer program can be easily inferred by a skilled computer programmer in the art. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus to remove noise input from a rear direction, the apparatus comprising:
an acoustic signal input unit configured to comprise three or more microphones including a first microphone as a reference microphone, a second microphone disposed at a position asymmetrical to the first microphone, and a third microphone disposed at a position symmetrical to the first microphone; and
an acoustic signal processing unit configured to remove rear noise using acoustic signals received from the first microphone, the second microphone, and the third microphone.

2. The apparatus of claim 1, wherein the acoustic signal processing unit is further configured to comprise
a frequency transformation unit configured to transform a first acoustic signal received by the first microphone, a second acoustic signal received by the second microphone, and a third acoustic signal received by the third microphone, respectively, into acoustic signals in a frequency domain;
a phase compensation unit configured to compensate for a phase of the second acoustic signal with respect to sound waves input from the rear direction such that a first directivity direction in which a first phase difference between the first acoustic signal and the second acoustic signal is equal to or smaller than a first threshold value is approximate to a second directivity direction in which a second phase difference between the first acoustic signal and the third acoustic signal is equal to or smaller than a second threshold value;
a first direction filter configured to form a first beam in such a direction that the first phase difference between the first acoustic signal and the second acoustic signal with the compensated phase is equal to or smaller than a predetermined threshold value;
a second direction filter configured to form a second beam in such a direction that the second phase difference between the first acoustic signal and the third acoustic signal is equal to or smaller than the predetermined threshold value; and
a beam processing unit configured to remove an acoustic signal input from the rear direction using the first beam and the second beam.

3. The apparatus of claim 1, wherein the symmetrical disposition of the microphones causes a phase difference between acoustic signals with respect to sound waves input from the back in a perpendicular direction to the apparatus to be equal to or smaller than a certain threshold value and the asymmetrical disposition of the microphones causes a phase difference between the acoustic signals with respect to the sound waves input from the back in a perpendicular direction to the apparatus to be equal to or greater than the certain threshold value.

4. The apparatus of claim 2, wherein the phase compensation unit is further configured to compensate for the phase of the second acoustic signal using a previously stored phase difference in order to make the first directivity direction approximate to the second directivity direction.

5. The apparatus of claim 4, wherein the previously stored phase difference is a phase difference between the first acoustic signal and the second acoustic signal with respect to the sound waves input from the back in the perpendicular direction to the apparatus.

6. The apparatus of claim 2, wherein the first direction filter is further configured to form a first weight filter using frequency components of a spectrogram in which a phase difference between the second acoustic signal with the compensated phase and the first acoustic signal is equal to or smaller than the predetermined threshold value, and apply the first weight filter to the first acoustic signal to obtain a first output signal.

7. The apparatus of claim 6, wherein the first direction filter is further configured to assign a value of 1 to frequency components of the spectrogram in which the phase difference between the first acoustic signal and the second acoustic signal with the compensated phase is equal to or smaller than the predetermined threshold value, and assign a value of 0 to the remaining frequency components of the spectrogram to generate the first weight filter.

8. The apparatus of claim 6, wherein the second direction filter is further configured to form a second weight filter using frequency components of a spectrogram in which a phase difference between the third acoustic signal and the first acoustic signal is equal to or smaller than the predetermined threshold value, and apply the second weight filter to the first acoustic signal to obtain a second output signal.

9. The apparatus of claim 8, wherein the second direction filter is further configured to assign a value of 1 to frequency components of the spectrogram in which the phase difference between the first acoustic signal and the third acoustic signal is equal to or smaller than the predetermined threshold value, and assign a value of 0 to the remaining frequency components of the spectrogram to generate the second weight filter.

10. The apparatus of claim 8, wherein the beam processing unit is further configured to form a beam processing filter using frequency components that allow a phase of the first output signal to be smaller than a predefined threshold value and allow a phase of the second output signal to be greater than the predefined threshold value, and apply the beam processing filter to the first acoustic signal to obtain an output signal from which rear noise is removed.

11. The apparatus of claim 10, wherein the beam processing unit is further configured to assign a value of 1 to frequency components that allow the phase of the first output signal to be smaller than the predefined threshold value and allow the phase of the second output signal to be greater than the predefined threshold value, and assign a value of 0 to the remaining frequency components to generate the beam processing filter.

12. A method of removing noise used in an apparatus to remove noise, the method comprising:
receiving acoustic signals using an acoustic signal input unit configured to include a first microphone as a reference microphone, a second microphone disposed at a position symmetrical to the first microphone, and a third microphone disposed at a position asymmetrical to the first microphone;
transforming a first acoustic signal received by the first microphone, a second acoustic signal received by the second microphone, and a third acoustic signal received by the third microphone, respectively, into acoustic signals in a frequency domain;
compensating for a phase of the second acoustic signal with respect to sound waves input from a rear direction such that a first directivity direction in which a first phase difference between the first acoustic signal and the second acoustic signal is equal to or smaller than a first threshold value is approximate to a second directivity direction in which a second phase difference between the first acoustic signal and the third acoustic signal is equal to or smaller than a second threshold value;
forming a first beam in such a direction that the first phase difference between the first acoustic signal and the second acoustic signal with the compensated phase is equal to or smaller than a predetermined threshold value;
forming a second beam in such a direction that the second phase difference between the first acoustic signal and the third acoustic signal is equal to or smaller than the predetermined threshold value; and
removing an acoustic signal input from the rear direction using the first beam and the second beam.

13. The method of claim 12, wherein the symmetrical disposition of the microphones causes a phase difference between acoustic signals with respect to sound waves input from the back in a perpendicular direction to the apparatus to be equal to or smaller than a certain threshold value and the asymmetrical disposition of the microphones causes a phase difference between the acoustic signals with respect to the sound waves input from the back in a perpendicular direction to the apparatus to be equal to or greater than the certain threshold value.

14. The method of claim 12, wherein the compensating for the phase comprises compensating for the phase of the second acoustic signal using a previously stored phase difference in order to make the first directivity direction approximate to the second directivity direction.

15. The method of claim 14, wherein the previously stored phase difference is a phase difference between the first acoustic signal and the second acoustic signal with respect to the sound waves input from the back in the perpendicular direction to the apparatus.

16. The method of claim 12, wherein the forming of the first beam comprises forming a first weight filter using frequency components of a spectrogram in which a phase difference between the second acoustic signal with the compensated phase and the first acoustic signal is equal to or smaller than the predetermined threshold value, and applying the first weight filter to the first acoustic signal to obtain a first output signal.

17. The method of claim 16, wherein the forming of the second beam comprises forming a second weight filter using frequency components of a spectrogram in which a phase difference between the third acoustic signal and the first acoustic signal is equal to or smaller than the predetermined threshold value, and applying the second weight filter to the first acoustic signal to obtain a second output signal.

18. The method of claim 17, wherein the removing of the acoustic signal input from the rear direction comprises forming a beam processing filter using frequency components that allow a phase of the first output signal to be smaller than a predefined threshold value and allow a phase of the second output signal to be greater than the predefined threshold value, and applying the beam processing filter to the first acoustic signal to obtain an output signal from which rear noise is removed.

19. The method of claim 18, wherein the removing of the acoustic signal input from the rear direction comprises assigning a value of 1 to frequency components that allow the phase of the first output signal to be smaller than the predefined threshold value and allow the phase of the second output signal to be greater than the predefined threshold value, and assigning a value of 0 to the remaining frequency components to generate the beam processing filter.

20. An apparatus to remove rear noise, the apparatus comprising:
an acoustic signal input unit configured to comprise three or more microphones disposed on a surface which is linearly symmetrical and including one reference microphone, at least one microphone disposed at a position symmetrical to the reference microphone with respect to a line of symmetry of the linearly symmetrical surface, and at least one microphone disposed at a position which is not symmetrical to the reference microphone with respect to the line of symmetry; and
an acoustic signal processing unit configured to remove the rear noise using acoustic signals input from the three or more microphones.

21. The apparatus of claim 20, wherein the acoustic signal input unit is further configured to comprise a first microphone as the reference microphone, a second microphone disposed at a position which is not symmetrical to the first microphone with respect to the line of symmetry, and a third microphone disposed at a position symmetrical to the first microphone with respect to the line of symmetry.

22. The apparatus of claim 21, wherein the acoustic signal processing unit is further configured to comprise:
a frequency transformation unit configured to transform a first acoustic signal received by the first microphone, a second acoustic signal received by the second microphone, and a third acoustic signal received by the third microphone, respectively, into acoustic signals in a frequency domain;
a phase compensation unit configured to compensate for a phase of the second acoustic signal with respect to sound waves input from the rear direction such that a first directivity direction in which a first phase difference between the first acoustic signal and the second acoustic signal is equal to or smaller than a first threshold value is approximate to a second directivity direction in which a second phase difference between the first acoustic signal and the third acoustic signal is equal to or smaller than a second threshold value;
a first direction filter configured to form a first beam in such a direction that the first phase difference between the first acoustic signal and the second acoustic signal with the compensated phase is equal to or smaller than a predetermined threshold value;
a second direction filter configured to form a second beam in such a direction that the second phase difference between the first acoustic signal and the third acoustic signal is equal to or smaller than the predetermined threshold value; and
a beam processing unit configured to remove an acoustic signal input from the rear direction using the first beam and the second beam.

23. A method of removing rear noise, the method comprising:
receiving signals from first, second, and third microphones on a shared surface, the second microphone being asymmetrical on the surface relative to the first microphone, and the third microphone being symmetrical on the surface relative to the first microphone;
compensating a phase of a signal received by the second microphone according to a phase difference between the signal received by the first microphone and the signal received by the second microphone; and
removing portions of the signals of which the phase difference between the signal received by the first microphone and the signal received by the second microphone is approximately the same as a phase difference between the signal received by the first microphone and the signal received by the third microphone.

24. The method of claim 23, wherein the phase of the signal received by the second microphone is compensated with respect to sound waves input from a rear perpendicular direction such that the phase difference between the signal received by the first microphone and the signal received by the second microphone is equal to or smaller than a first threshold value.

25. The method of claim 23, wherein the symmetrical disposition of the microphones causes a phase difference between the signals with respect to sound waves input from a rear perpendicular direction to be equal to or smaller than a certain threshold value, and the asymmetrical disposition of the microphones causes a phase difference between the signals with respect to the sound waves input from the rear perpendicular direction to be equal to or greater than the certain threshold value.

26. A device comprising:
an apparatus to remove noise, the apparatus comprising:
first, second, and third microphones provided on a shared surface to receive signals, the second microphone being asymmetrical on the surface relative to the first microphone, and the third microphone being symmetrical on the surface relative to the first microphone, and
a controller to compensate a phase of a signal received by the second microphone according to a phase difference between the signal received by the first microphone, and the signal received by the second microphone to remove portions of the signals of which the phase difference between the signal received by the first microphone and the signal received by the second microphone is approximately the same as a phase difference between the signal received by the first microphone and the signal received by the third microphone.

27. The device of claim 26, wherein the phase of the signal received by the second microphone is compensated with respect to sound waves input from a rear perpendicular direction such that the phase difference between the signal received by the first microphone and the signal received by the second microphone is equal to or smaller than a first threshold value.
